(19) United States
(12) Patent Application Publication
(10) Pub. No.: US 2020/0051020 A1
(43) Pub. Date: Feb. 13, 2020

(54) METHOD AND SYSTEM TO PREDICT COST OF TRANSPORTATION OF GOODS

(71) Applicant: Vyomi Technetwork Services Private Limited, Gurugram (IN)

(72) Inventors: Kapish SARAF, Gurugram (IN); Tushar MAKKAR, Gurugram (IN)

(21) Appl. No.: 16/059,426

(22) Filed: Aug. 9, 2018

(51) Int. Cl. G06Q 10/08; G06Q 30/02; G06F 15/18; G06Q 50/30

(52) U.S. Cl. CPC G06Q 10/08355; G06Q 50/30; G06F 15/18; G06Q 30/0283

(57) ABSTRACT

The present disclosure provides a method and system to predict cost of transportation of goods for one or more trips. The method includes a first step of receiving a first set of data. In addition, the method includes a second step of fetching a historical data associated with the transportation. Further, the method includes a third step of creating a profile of each type of vehicle of a plurality of vehicles and a fourth step of creating a profile of the plurality of lanes. Furthermore, the method includes a fifth step of analyzing the first set of data, the historical data and the profile of vehicles. The method includes a sixth step of calculating the estimated cost of transportation and a seventh step of displaying the estimated cost of transportation to a user on one or more communication devices.

### INTRODUCTION

A number of businesses, factories and industries require transportation facilities to transport goods between cities, states and countries. Multiple logistic organizations and transportation companies provide transportation facilities to the customers for transporting goods. The cost of transportation varies from one company to another company. Most of the transportation companies do not provide the real transport cost. The transportation cost provided by the companies may vary due to multiple factors. The multiple factors may include fuel prices, vehicle conditions, agent cost, hidden charges and supply demand gap between source and destination. The variance in cost of transportation of different companies creates a nuisance for the customer. The customer faces difficulty in deciding that which company is providing the real cost of transportation. Thus, there is no such transparency between the companies and the customers. Thus, there is a need for a system which can overcome the above-stated disadvantages.

### SUMMARY

In a first example, a computer-implemented method is provided. The computer-implemented method is configured to predict the cost of transportation for one or more trips. The computer-implemented method may include a first step of receiving a first set of data associated with one or more trips for transporting goods from a source place to a destination place. In addition, the computer-implemented method may include a second step of fetching a historical data associated with transportation. Further, the computer-implemented method may include a third step of creating a profile of each type of vehicle of a plurality of vehicles by utilizing the historical data and the real-time data associated with the plurality of vehicles. Further, the computer-implemented method may include a fourth step of creating a profile of the plurality of lanes by utilizing the historical data and the real-time data associated with the plurality of lanes. Moreover, the computer-implemented method may include a fifth step of analyzing the first set of data, the historical data and the data associated with the profile of each type of vehicle and profile of the plurality of lanes by utilizing machine learning and regression techniques. Furthermore, the computer-implemented method may include a sixth step of calculating the estimated cost of transportation for the one or more trips based on the analyses of the first set of data, the historical data and the data associated with the profile of each type of vehicle and the profile of the plurality of lanes. Also, the computer-implemented method may include a seventh step of displaying the estimated cost of transporting goods from the source place to the destination place of the one or more trips. Also, the computer-implemented method may include an eighth step of the updating the estimated cost of transporting goods for the one or more trips on the real-time dynamic basis. The first set of data is received from a user through one or more communication devices. In addition, the one or more communication devices are associated with the user. The historical data is obtained from a plurality of sources. In addition, the historical data includes a set of data associated with the plurality of vehicles and a plurality of lanes. The profile of each type of vehicle is created based on a plurality of factors. The profile of the plurality of lanes is based on a plurality of historical lanes parameters. The first set of data, the historical data, the data associated with the profile of each type of vehicle and the profile of the plurality of lanes are analyzed to identify the pattern similar to the first set of data. The analyzing is done in real-time. The estimated cost is displayed on the one or more communication devices associated with the user. The estimated cost is updated based on a plurality of parameters.

In an embodiment of the present disclosure, the first set of data includes a source place, a destination place, preference in selecting the type of vehicle, preference in selecting the length of the vehicle. In addition, the first set of data includes preference in selecting capacity of the vehicle, data associated with the type of material to be transported, loading and unloading details. The data associated with the type of material includes packaged boxes, consumer boxes, food and agriculture, machine/auto parts, electronic goods, chemical powder, scrap. In addition, the data associated with the type of material includes construction material, petroleum/paint, tyre, battery, cylinders, alcoholic beverages.

In an embodiment of the present disclosure, the historical data further includes price data associated with one or more past trips, data associated with the plurality of vehicles used in past trips. In addition, the historical data includes data associated with the one or more lanes used in past trips, data associated with a plurality of drivers, data associated with a plurality of source points and destination points. Further, the historical data includes data associated with the occurrence of entropy in the one or more past trips, data associated with the one or more past trips. The plurality of sources includes crowd sourcing from suppliers and stored database related to historical experience.

In an embodiment of the present disclosure, the plurality of factors associated with the profiling of vehicles includes the size of vehicles, the weight of vehicles, the material of vehicles, and energy consumption rate of vehicles. In addition, the plurality of factors associated with the profiling of vehicles includes efficiency of vehicles, a model of vehicles, purchasing history of vehicles, the maintenance history of vehicles, and capacity of vehicles.

In an embodiment of the present disclosure, the computer-implemented method includes yet another step of storing the first set of data, the historical data, the data associated with the profile of each type of vehicles and data associated with the estimated cost.

In an embodiment of the present disclosure, the plurality of historical lanes parameters includes source point, destination point, the width of the lane, traffic probability, a total distance of lane and time taken to cover the distance of lane.

In an embodiment of the present disclosure, the profile of the lanes is analyzed to calculate the amount of fuel required for the one or more trips, cost of fuel required for the one or more trips, toll amount required for the one or more trips and selecting the optimized lane for the one or more trips.

In an embodiment of the present disclosure, the plurality of parameters includes the occurrence of entropy in the one or more trips or one or more similar trips, one or more offers or discounts in the parameters associated with the one or more trips, peak seasons.

In an embodiment of the present disclosure, the computer-implemented method includes yet another step of creating clusters of the one or more similar trips by applying algorithms over the historical data and the first set of data. In addition, the clusters of the one or more similar trips are analyzed in real-time for estimating the cost of the one or more trips.

In an embodiment of the present disclosure, the historical data further includes a data associated with a plurality of lanes. The data associated with the plurality of lanes is used to determine the linkage between one or more parent lanes and corresponding one or more child lanes. The linkage between the one or more parent lanes and the corresponding one or more child lanes is used to determine the cost of transportation for the one or more trips.

In an embodiment of the present disclosure, the estimated cost of transportation for the one or more trips is calculated by taking one or more factors into consideration. The one or more factors include dry run of vehicle for a certain distance, demand availability, manufacturing and agriculture GDP (gross domestic product) of origin and destination place.

In a second example, a computer system is provided. The computer system may include one or more processors and a memory coupled to the one or more processors. The memory may store instructions which, when executed by the one or more processors, may cause the one or more processors to perform a method. The method is configured to predict the cost of transportation based on the historical data. The method may include a first step of receiving a first set of data associated with one or more trips for transporting goods from a source place to a destination place. In addition, the method may include a second step of fetching a historical data associated with transportation. Further, the method may include a third step of creating a profile of each type of vehicle of the plurality of vehicles by utilizing the historical data and the real-time data associated with the plurality of vehicles. Further, the method may include a fourth step of creating a profile of the plurality of lanes by utilizing the historical data and the real-time data associated with the plurality of lanes. Moreover, the method may include a fifth step of analyzing the first set of data, the historical data, the data associated with the profile of each type of vehicle and profile of the plurality of lanes by utilizing machine learning and regression techniques. Furthermore, the method may include a sixth step of calculating the estimated cost of transportation for the one or more trips based on the analyses of the first set of data, the historical data and the data associated with the profile of each type of vehicle and the profile of the plurality of lanes. Also, the method may include a seventh step of displaying the estimated cost of transporting goods from the source place to the destination place of the one or more trips. Also, the method may include an eighth step of the updating the estimated cost of transporting goods for the one or more trips on the real-time dynamic basis. The first set of data is received from a user through one or more communication devices. In addition, the one or more communication devices are associated with the user. The historical data is obtained from a plurality of sources. In addition, the historical data includes a set of data associated with the plurality of vehicles and a plurality of lanes. The profile of each type of vehicle is created based on a plurality of factors. The profile of the plurality of lanes is based on a plurality of historical lanes parameters. The first set of data, the historical data and the data associated with the profile of each type of vehicle and the profile of the plurality of lanes are analyzed to identify the pattern similar to the first set of data. The analyzing is done in real-time. The estimated cost is displayed on the one or more communication devices associated with the user. The estimated cost is updated based on a plurality of parameters.

In an embodiment of the present disclosure, the first set of data includes a source place, a destination place, preference in selecting the type of vehicle, preference in selecting the length of the vehicle. In addition, the first set of data includes preference in selecting capacity of the vehicle, data associated with the type of material to be transported; loading and unloading details. The data associated with the type of material includes packaged boxes, consumer boxes, food and agriculture, machine/auto parts, electronic goods, chemical powder, scrap. In addition, the data associated with the type of material includes construction material, petroleum/paint, tyre, battery, cylinders, alcoholic beverages.

In an embodiment of the present disclosure, the historical data further includes price data associated with one or more past trips, data associated with the plurality of vehicles used in past trips. In addition, the historical data includes data associated with one or more lanes used in past trips, data associated with a plurality of drivers, data associated with a plurality of source points and destination points. Further, the historical data includes data associated with the occurrence of entropy in the one or more past trips, data associated with the one or more past trips. The plurality of sources includes crowd sourcing from suppliers and stored database related to historical experience.

In an embodiment of the present disclosure, the plurality of factors associated with the profiling of vehicles includes the size of vehicles, the weight of vehicles, the material of vehicles, and energy consumption rate of vehicles. In addition, the plurality of factors associated with the profiling of vehicles includes efficiency of vehicles, model of vehicles, purchasing history of vehicles, the maintenance history of vehicles, and capacity of vehicles.

In an embodiment of the present disclosure, the method further includes another step of storing the first set of data, the historical data, the data associated with the profile of each type of vehicle and data associated with the estimated cost.

In an embodiment of the present disclosure, the plurality of historical lanes parameters includes source point, destination point, the width of the lane, traffic probability, a total distance of lane and time taken to cover the distance of lane.

In an embodiment of the present disclosure, the profile of the lanes is analyzed to calculate the amount of fuel required for the one or more trips, cost of fuel required for the one or more trips, toll amount required for the one or more trips and selecting the optimized lane for the one or more trips.

In an embodiment of the present disclosure, the plurality of parameters includes the occurrence of entropy in the one or more trips or one or more similar trips, one or more offers or discounts in the parameters associated with the one or more trips, peak seasons.

In an embodiment of the present disclosure, the method includes another step of creating clusters of the one or more similar trips by applying algorithms over the historical data and the first set of data. In addition, the clusters of the one or more similar trips are analyzed in real-time to estimate the cost of the one or more trips.

In an embodiment of the present disclosure, the historical data further includes a data associated with a plurality of lanes. The data associated with the plurality of lanes is used to determine the linkage between one or more parent lanes and corresponding one or more child lanes. The linkage between the one or more parent lanes and the corresponding one or more child lanes is used to determine the cost of transportation for the one or more trips.

In an embodiment of the present disclosure, the estimated cost of transportation for the one or more trips is calculated by taking one or more factors into consideration. The one or more factors include dry run of vehicle for a certain distance, demand availability, manufacturing and agriculture GDP (gross domestic product) of origin and destination place.

In a third example, a computer-readable storage medium is provided. The computer-readable storage medium encodes computer executable instructions that, when executed by at least one processor, performs a method. The method is configured to predict the cost of transportation for one or more trips based on the historical data. The method may include a first step of receiving a first set of data associated with one or more trips for transporting goods from a source place to a destination place. In addition, the method may include a second step of fetching a historical data associated with transportation. Further, the method may include a third step of creating a profile of each type of vehicle of a plurality of vehicles by utilizing the historical data and the real-time data associated with the plurality of vehicles. Further, the method may include a fourth step of creating a profile of the plurality of lanes by utilizing the historical data and the real-time data associated with the plurality of lanes. Moreover, the method may include a fifth step of analyzing the first set of data, the historical data, the data associated with the profile of each type of vehicle and profile of the plurality of lanes and the data associated with a plurality of lanes by utilizing machine learning and regression techniques. Furthermore, the method may include a sixth step of calculating the estimated cost of transportation for the one or more trips based on the analyses of the first set of data, the historical data, the data associated with the profile of each type of vehicle and the data associated with the plurality of lanes. Also, the method may include a seventh step of displaying the estimated cost of transporting goods from the source place to the destination place of the one or more trips. Also, the method may include an eighth step of the updating the estimated cost of transporting goods for the one or more trips on real-time dynamic basis. The first set of data is received from a user through one or more communication devices. In addition, the one or more communication devices are associated with the user. The historical data is obtained from a plurality of sources. In addition, the historical data includes a set of data associated with the plurality of vehicles and a plurality of lanes. The profile of each type of vehicle is created based on a plurality of factors. The profile of the plurality of lanes is based on a plurality of historical lanes parameters. The first set of data, the historical data, the data associated with the profile of each type of vehicle and the data associated with the plurality of lanes is analyzed to identify the pattern similar to the first set of data. The analyzing is done in real-time. In addition, the data associated with the plurality of lanes is analyzed to determine the linkage in between one or more parent lanes and corresponding one or more child lanes. The linkage in between the one or more parent lanes and the corresponding one or more child lanes is determined using machine learning algorithms over the data associated with the plurality of lanes. The estimated cost is displayed on the one or more communication devices associated with the user. The estimated cost is updated based on a plurality of parameters. The plurality of sources includes crowd sourcing from suppliers and the stored database related to historical experience.

### BRIEF DESCRIPTION OF THE DRAWINGS

Having thus described the invention in general terms, reference will now be made to the accompanying drawings, which are not necessarily drawn to scale, and wherein:

FIG. 1A illustrates an interactive computing environment for enabling real-time cost prediction of transportation to a user for one or more trips, in accordance with various embodiments of the present disclosure;

FIG. 1B illustrates an example of linkage between child lane and parent lane, in accordance with an embodiment of the present disclosure:

FIG. 2A and FIG. 2B illustrates a flowchart for a method to predict the cost of transportation in real time based on the historical data, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present invention in conjunction with accompanying figures. The embodiments described herein are not intended to limit the scope of the invention, and the present invention should not be construed as limited to the embodiments described. This invention may be embodied in different forms without departing from the scope and spirit of the invention. It should be understood that the accompanying figures are intended and provided to illustrate embodiments of the invention described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

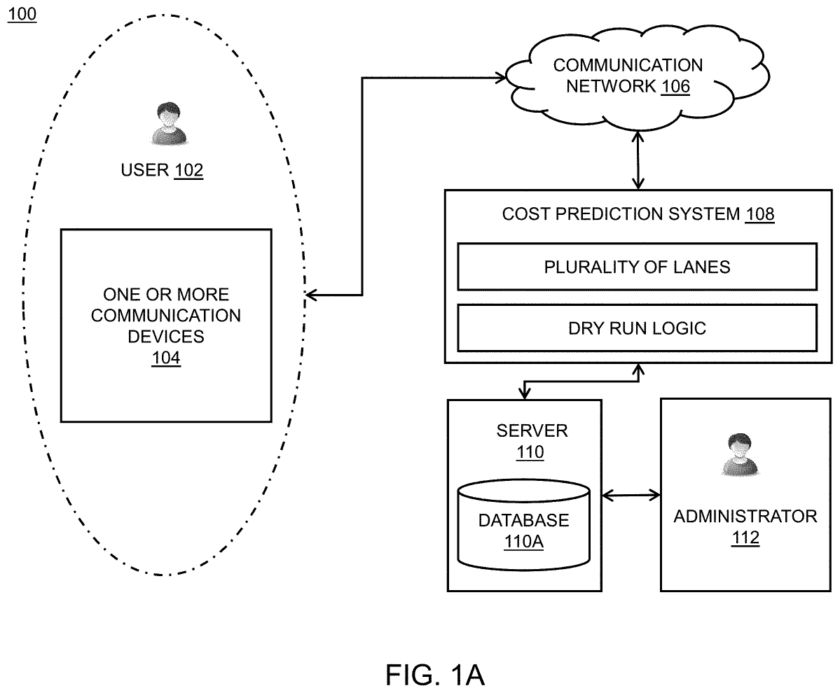

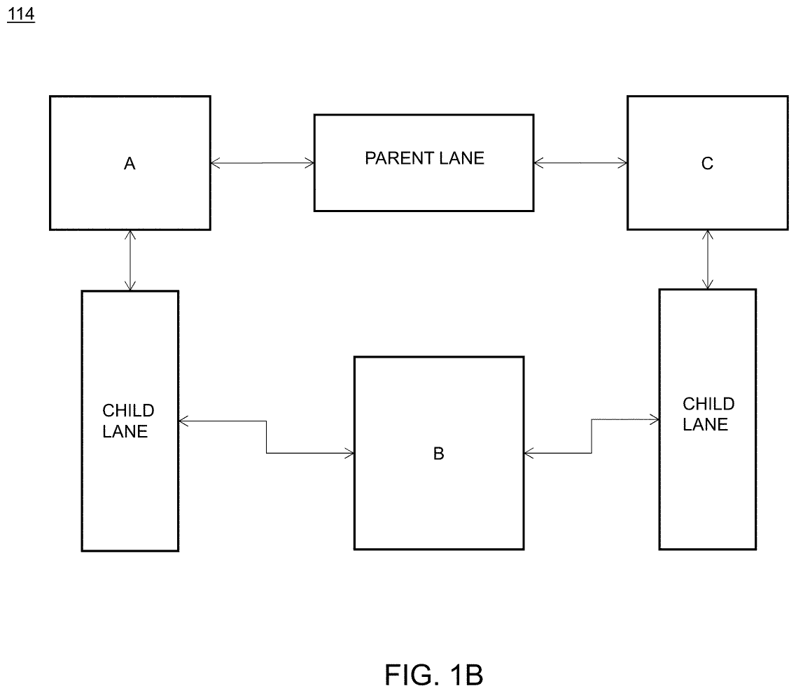

FIG. 1A illustrates an interactive computing environment 100 for enabling real-time prediction of transportation cost, in accordance with various embodiments of the present disclosure. The block diagram 100 includes a user 102, one or more communication devices 104, a communication network 106, a cost prediction system 108. In addition, the block diagram 100 includes a server 110, a database 110a and an administrator 112. The above-stated elements of the interactive computing environment 100 enable the prediction of the cost of transportation for one or more trips to the user 102 in real time.

The interactive computing environment 100 includes the user 102. The user 102 may be a person or individual looking to check the cost for the one or more trips for transporting goods from one place to another place. In addition, the user 102 may be the owner of a factory who wants to transport his goods and product from one state to another state. The user 102 may be a person who wants to check the cost required for the transportation of the products and goods from one place to another place. In an example, the user 102 may be the person who wants to check the cost of the trip in real-time for transporting goods from X place to Y place. The user 102 checks the cost by providing details of the trips on the one or more communication devices 104. The user 102 is associated with the one or more communication devices 104 for checking the cost of the one or more trips.

The interactive computing environment 100 includes the one or more communication devices 104. In an embodiment of the present disclosure, the user 102 may be an owner of the one or more communication devices 104. In another embodiment of the present disclosure, the user 102 may not be the owner of the one or more communication devices 104. The user 102 accesses the one or more communication devices 104 in real time. The one or more communication devices 104 are any type of devices which allows the user 102 to check the price of one or more trips in real-time. In addition, the one or more communication devices 104 are the devices having an active internet facility. In an example, the one or more communication devices 104 includes but may not be limited to a smartphone, a tablet, a laptop, a desktop computer, a personal digital assistant, a smart television, a workstation and an electronic wearable device. In an embodiment, the one or more communication devices 104 include portable communication device such as the Smartphone, and the laptop. In another embodiment, the one or more communication devices 104 include fixed communication devices such as the desktop computer, the Smart television. In addition, the one or more communication devices 104 include an application installed on the one or more communication devices 104. In an example, the application is associated with a cost prediction platform. Further, the one or more communication devices 104 are associated with a specific type of operating system. The specific type of operating system includes an Android operating system, a Windows operating system, a Mac operating system and the like. In addition, the one or more communication devices 104 are connected to the internet in real time. Moreover, the one or more communication devices 104 are connected to the internet through the communication network 106. Further, the one or more communication devices 104 are connected to the internet through a data connection provided by a telecom service provider. The telecom service provider is associated with a subscriber identification module card located inside the one or more communication devices 104. In an embodiment of the present disclosure, the one or more communication devices 104 may be connected to the internet through a WiFi connection. In another embodiment of the present disclosure, the one or more communication devices 104 may be connected to the internet through a wired connection. Further, each of the one or more communication devices 104 consumes a specific amount of electrical energy for operation in real time.

The one or more communication devices 104 are associated with the cost prediction system 108. In addition, the one or more communication devices 104 are associated with the cost prediction system 108 through the Communication network 106. The Communication network 106 enables the one or more communication devices 104 to gain access to the internet. Moreover, the Communication network 106 provides a medium for transfer of information between the one or more communication devices 104 and the cost prediction system 108. Further, the medium for the communication may be infrared, microwave, radio frequency (RF) and the like. The Communication network 106 includes but may not be limited to a local area network, a metropolitan area network, a wide area network, a virtual private network. In addition, the Communication network 106 includes a global area network, a home area network or any other Communication network 106 presently known in the art. The Communication network 106 is a structure of various nodes or communication device connected to each other through a network topology method. Examples of the network topology include a bus topology, a star topology, a mesh topology and the like.

The interactive computing environment 100 includes the cost prediction system 108. The cost prediction system 108 performs the prediction of the cost of transportation for one or more trips. In addition, the cost prediction system 108 predicts the cost of transportation based on the requirement of the user 102. The cost prediction system 108 receives a first set of data from the user 102. The first set of data is associated with the one or more trips of transporting goods from a source place to a destination place. The user 102 provides the first set of data through the application installed on the one or more communication devices 104. The one or more communication devices 104 are associated with the user 102. In addition, the first set of data includes the source place, the destination place, preference in selecting the type of the vehicle, preference in selecting the length of the vehicle, preference in selecting capacity of the vehicle. Further, the first set of data includes the data associated with the type of the material to be transported, loading and unloading details. In addition, the data associated with the type of the material includes packaged boxes, consumer boxes, food and agriculture, machine/auto parts, electronic goods, chemical powder, scrap, construction material, petroleum/paint. Further, the data associated with the type of material includes tyre, battery, cylinders and alcoholic beverages. In an embodiment, the data associated with the type of material may include any kind of material which needs to be transported.

In an example, the user X access the platform associated with the cost prediction system 108. The user X wants to transport 5000 units of the Mobile charger from city A to city B. At first step, the user X fills the invoice name details in the mobile application associated with the platform. At the second step, the user X fills the source place as city A and the destination place as city B. At the third step, the user X selects the type of vehicle. In an example, the user X selects container truck from the one or more options. At the fourth step, the user X selects 14 tires as the length of the truck from the one or more options. At the fifth step, the user X selects the desired capacity of the truck from the one or more options according to the number of units of the mobile charger to be transported. At the sixth step, the user X selects electronic goods as the category of material from the one or more options. At the seventh step, the user X selects the data and time of loading. At the eighth step, the user X may provide any remark associated with the requested trip.

After receiving the first set of data, the cost prediction system 108 fetches a historical data associated with the transportation. The historical data includes price data associated with one or more past trips, data associated with a plurality of vehicles, data associated with one or more lanes. In addition, the historical data includes the data associated with a plurality of drivers, data associated with a plurality of source points and destination points, data associated with the occurrence of entropy in past trips, data associated with the one or more past trips. In an embodiment, the historical data includes the data required for the prediction of the cost of transportation. In addition, the historical data is obtained from a plurality of sources. The plurality of sources includes crowd sourcing from suppliers and stored database related to the historical experience. In an embodiment, the plurality of sources includes online travel aggregators, competitors, web-based platforms. In an example, the historical data is fetched from the database in real-time.

The historical data includes a set of data associated with the plurality of vehicles used for the transportation. The set of data associated with the plurality of vehicles is used for creating a profile of each type of vehicle of the plurality of vehicles. The cost prediction system 108 creates the profile of each type of vehicle of the plurality of vehicles by utilizing the historical data and the real-time data associated with the plurality of vehicles. The profile of each type of vehicle is created based on a plurality of factors. The plurality of factors is associated with the profiling of vehicles. The plurality of factors includes the size of vehicles, the weight of vehicles, the material of vehicles, energy consumption rate of vehicles, efficiency of the vehicles, model of vehicles, purchasing history of vehicles. In addition, the plurality of factors includes maintenance history of vehicles and capacity of vehicles.

In an example, the cost prediction system 108 creates a profile for A type of trucks including all the features involved in A type of trucks. The features may include color, type of material of the truck, capacity of the truck, tyre of the truck, weight of the truck, efficiency of truck, body of truck and dimensions of the truck.

The historical data includes a set of data associated with the lanes. The cost prediction system 108 creates a profile of the lanes associated with the one or more trips. The profile of the lanes is created based on the historical data. In addition, the profile of the lanes is created based on a plurality of historical lanes parameters. The plurality of historical lanes parameters includes source point, destination point, the width of the lane, traffic probability, a total distance of lane and time taken to cover the total distance of lane. In an example, the user wants to deliver a plurality of products from place A to place B place within a short period of time. Thus, the profile of the lanes facilitates in getting a best suitable lane to transport the plurality of products from the place A to the place B.

In an embodiment of the present disclosure, the cost prediction system 108 predicts cost of transportation based on lane hierarchy of multiple lanes between source and destination. In addition, the historical data includes a data associated with a plurality of lanes. The data associated with the plurality of lanes is used to predict the cost of the one or more trips. The cost prediction system 108 uses the data associated with the plurality of lanes to predict the cost of the one or more trips. In an example, the cost prediction system 108 uses the data of one lane to predict the cost of transportation for other lanes. In addition, the cost prediction system 108 uses the data associated with the plurality of lanes and the type of vehicles to predict the cost of the trip on other lanes

In an example, a country X has 360,000 lanes for the freight transportation. In addition, 30 types of vehicles are run on each lane to transport goods from one place to another place. The cost prediction system 108 has the data of 180,000 lanes with the type of vehicles run over the 180,000 lanes. Thus, the cost prediction system 108 uses the data of 180,000 lanes to predict the cost of transportation over the other 180,000 lanes.

Further, the cost prediction system 108 predicts the cost of transportation on one or more child lanes based on the data associated with the one or more parent lanes. The parent lane refers to the large lane covering one or more smaller lanes. In addition, the one or more smaller lanes are referred to as child lane. The cost prediction system 108 has the historical data associated with the plurality of lanes. The historical data includes a data associated with one or more parent lanes. In addition, the data associated with the one or more parent lanes is used to predict the cost of transportation over the one or more child lanes and vice-versa. The one or more child lanes are linked to the corresponding parent lane of the one or more parent lanes. Moreover, the linkage between the one or more child lanes and the one or more parent lanes is determined using machine learning algorithms over the data associated with the plurality of lanes. The linkage between the one or more child lanes and the one or more parent lanes is used to determine the cost of the one or more trips.

FIG. 1B illustrates an example 114 of linkage between the child lane and the parent lane, in accordance with an embodiment of the present disclosure. The parent lane is defined from origin A to destination C. The parent lane includes a first child lane and a second child lane. The first child lane may be defined with origin A to a destination B and the second child lane may be defined with origin B to destination C. The cost prediction system 108 has the data associated with the parent lane A to B. In an example, the data may include availability of vehicles at origin points and destination points, type of vehicles run over the parent lane for transportation. Based on the data, the cost prediction system 108 predicts the price of transportation over the child lanes A to B and B to C. In another example, the cost prediction system 108 predicts the price of transportation for a type of vehicle on the child lane based on the data associated with a same type of vehicle on the parent lane.

Further, any change in data associated with the parent lane also affects the price of transportation over the child lanes. In addition, whenever there is any change in the price of transportation over the parent lane, the price of transportation over the child lanes also gets affected. Thus, the cost prediction system 108 updates the price of transportation over the one or more child lanes on real-time dynamic basis based on the update in price over the parent lane.

In an embodiment, the cost prediction system 108 creates clusters of the one or more similar trips by applying algorithms over the historical data and the first set of data. In an example, the cost prediction system 108 creates a cluster of such trips which are similar to the one or more trips.

The cost prediction system 108 analyzes the first set of data, the historical data and the data associated with the profile of each type of vehicle by utilizing machine learning and regression techniques. In addition, the cost prediction system 108 analyzes the data associated with the profile of lanes and the plurality of lanes. The first set of data and the historical data is analyzed to identify the pattern similar to the first set of data. In addition, the first set of data, the historical data, profile of the vehicles and the profile of the lanes is analyzed in real-time for calculating the estimated cost of transportation for the one or more trips. Further, the cost prediction system 108 analyzes the first set of data and the historical data by mapping the first set of data with the historical data. Furthermore, the cost prediction system 108 analyzes the clusters of the one or more similar trips for estimating the cost of the one or more trips. In an example, the cost prediction system 108 analyzes the data by mapping the first set of data with the data of clusters of the one or more similar trips. Furthermore, the profile of the lanes is analyzed based on the pickup and delivery date/time.

The cost prediction system 108 calculates the estimated cost of transportation for the one or more trips based on the analyzing of the first set of data, the historical data and the profile of the vehicles. In addition, the cost prediction system 108 analyzes the clusters of the one or more similar trips to estimate the cost of transportation for the one or more trips. Further, the cost prediction system 108 analyzes the profile of lanes to estimate the cost of transportation for the one or more trips.

The profile of the lanes is analyzed to calculate the amount of fuel required for the one or more trips, cost of fuel required for the one or more trips and toll amount required for the one or more trips. In addition, the profile of the lanes is analyzed to select the optimized lane for the one or more trips. The cost prediction system 108 display the estimated cost of transporting goods from the source place to the destination place. In addition, the estimated cost of transportation is displayed on the display of the one or more communication devices 104. The one or more communication devices are associated with the user 102. The estimated cost is displayed on the one or more communication devices 104 in real-time for the one or more trips.

The cost prediction system 108 updates the estimated cost of transporting goods for the one or more trips on the real-time dynamic basis. The estimated cost is updated based on a plurality of parameters. The plurality of parameters includes the occurrence of entropy in the one or more trips or one or more similar trips, one or more offers or discounts in the parameters associated with the one or more trips, peak seasons. In an example, the entropy may be in the form of blocking of the lane, high traffic on the lane, unavailability of fuel, the occurrence of random issues in the vehicle and the like.

In an embodiment, the cost prediction system 108 predicts the cost of transporting goods for the one or more trips by taking one or more factors into consideration. The one or more factors include dry run of vehicle for a certain distance in the one or more trip. The dry run of vehicle refers to the moving of vehicles without carrying any goods.

In an example, A and C is the point where the plurality of trucks is available for the transportation of goods. The user 102 wants to transport goods from a point B to the point C. In addition, B is the point located in between the point A and the point C. Thus, a truck from the plurality of trucks has to run empty from point A to the point B because of unavailability of trucks at point B. After reaching at point B, the truck gets loaded with goods to transport the goods from point B to the point C. The truck runs empty (dry run) from point A to point B and runs loaded from the point B to the point C. The cost prediction system 108 predicts the cost of transportation for the user 102 by taking both the situation into consideration. The cost prediction system 108 predicts the cost of transportation by calculating the price of trip from the point A to the point B and then from the point B to the point C. The cost prediction system 108 predicts the overall cost of the trip by combing the cost of trip from the point A to the point B and then from the point B to the point C.

In an embodiment, the one or more factors include demand availability at origin or destination, manufacturing and agriculture GDP (gross domestic product) for origin and destination points. The manufacturing and agriculture GDP helps in determining the demand availability of transportation at origin or destination places. In addition, the cost prediction system 108 uses GDP of both places (Origin and destination) to determine the place with high demand of transportation. Thus, based on the demand availability, manufacturing and agriculture GDP, the cost prediction system 108 predicts the cost of the one or more trips.

In an example, there are two places M and N for the movement of truck. A plurality of goods manufacturing units are present at place M due to which the .GDP at place M is high. The cost prediction system 108 determines the relative price for the transportation of goods from place M to place N and vice versa by considering the factor of demand availability. In addition, the cost prediction system 108 uses the relative GDP of the two places to predict the price of transportation.

In an example, the user X wants the price of transportation from a place S to a place T. The cost prediction system 108 identifies that the place S has high GDP than the GDP of place T. In addition, the cost prediction system 108 has the price data associated with the transportation of goods from the place T to the place S. Thus, based on the GDP data and the price data, the cost prediction system 108 predicts the cost of transportation from the place S to the place T. In an example, the price of transportation from the place S to the place T is higher than the price of transportation from the place T to the place S due to having high GDP of place S. Moreover, the data is stored in the database 110A of the server 110.

The cost prediction system 108 is associated with the server 110. The server 110 handles each operation and task performed by the cost prediction system 108. The server 110 stores one or more instructions for performing the various operations of the cost prediction system 108. In an embodiment of the present disclosure, the cost prediction system 108 is located in the server 110. In another embodiment of the present disclosure, the cost prediction system 108 is located in the one or more communication devices 104. In addition, the server 110 comprises the database 110A. The database 110A is the storage location of all the data associated with the cost prediction system 108. The cost prediction system 108 stores the data in the database 110A. The database 110A includes the data related to the estimated cost. In addition, the database 110A includes the first set of data, the historical data, the data associated with the profile of each type of vehicle and the estimated cost of the one or more trips. Further, the database 110A includes the data associated with the profiles of the lanes. In an embodiment of the present disclosure, the database 110A includes the data required for estimating the cost of the one or more trips in future.

The cost prediction system 108 is associated with the administrator 112. The administrator 112 is any person or individual who monitors the working of the cost prediction system 108 in real time. The administrator 112 monitors the working of the cost prediction system 108 through a communication device. The communication device includes a laptop, a desktop computer, a tablet, a personal digital assistant and the like.

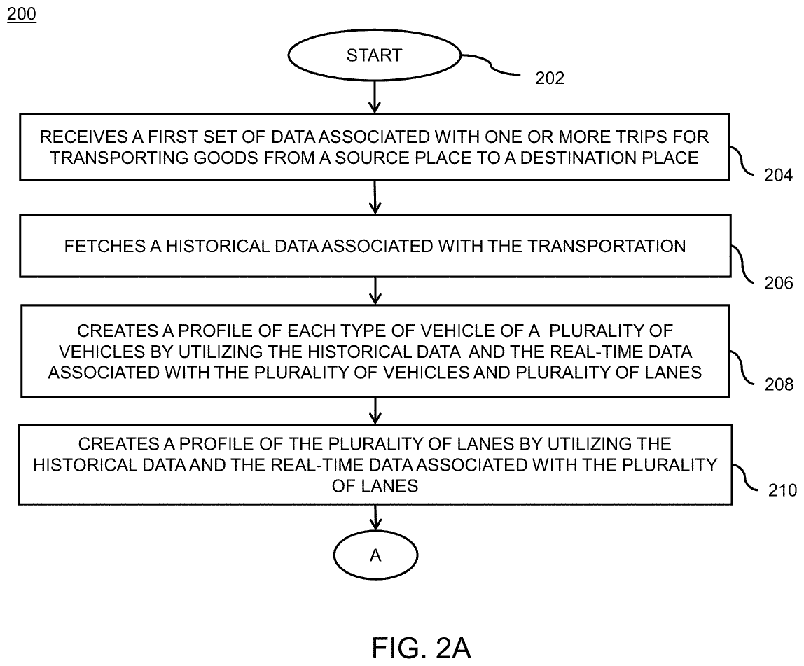

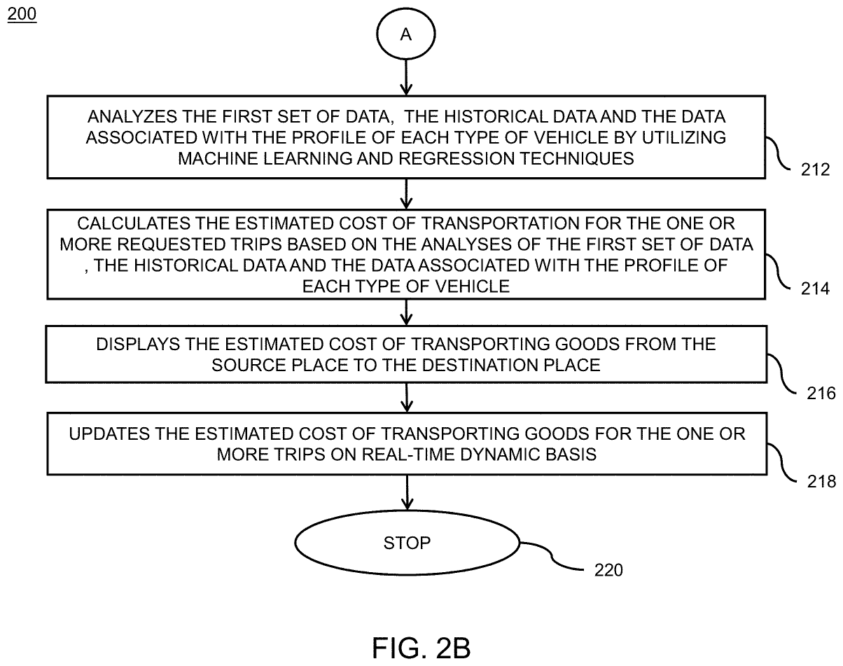

FIG. 2A and FIG. 2B illustrates a flowchart 200 for a method to predict the cost of transportation for one or more trips in real-time, in accordance with various embodiments of the present disclosure. It may be noted that to explain the process steps of the flowchart 200, references will be made to the system elements of FIG. 1. It may be noted that the flowchart 200 may have lesser or more number of steps.

The flowchart 200 initiates at step 202. Following step 202, at step 204, the cost prediction system 108 receives a first set of data associated with one or more trips for transporting goods from a source place to a destination place. At step 206, the cost prediction system 108 fetches a historical data associated with the transportation. At step 208, the cost prediction system 108 creates a profile of each type of vehicle of a plurality of vehicles by utilizing the historical data and the real-time data associated with the plurality of vehicles. At step 210, the cost prediction system 108 creates a profile of the plurality of lanes by utilizing the historical data and the real-time data associated with the plurality of lanes. At step 212, the cost prediction system 108 analyzes the first set of data, the historical data and the data associated with the profile of each type of vehicle by utilizing machine learning and regression techniques. At step 214, the cost prediction system 108 calculates the estimated cost of transportation for the one or more trips based on the analyses of the first set of data, the historical data and the data associated with the profile of each type of vehicle. At step 216, the cost prediction system 108 displays the estimated cost of transporting goods from the requested source place to the destination place. At step 218, the cost prediction system 108 updates the estimated cost of transporting goods for the one or more trips on the real-time dynamic basis. The flow chart 200 terminates at step 220.

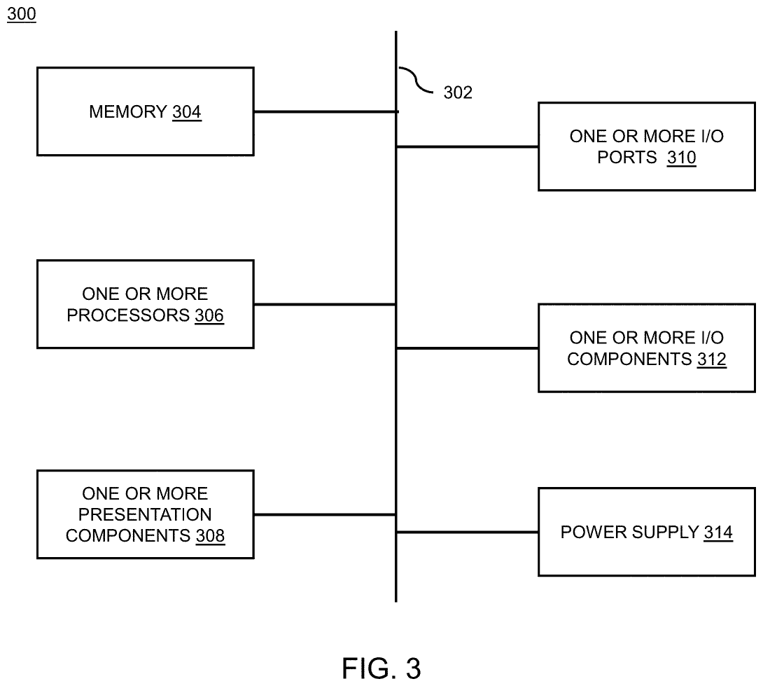

FIG. 3 illustrates a block diagram of a computing device 300, in accordance with various embodiments of the present disclosure. The computing device 300 is associated with a non-transitory computer readable storage medium. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for sake of clarity, in reality, delineating various components is not so clear, and metaphorically, the lines would more accurately be grey and fuzzy. For example, one may consider a presentation component such as a display device to be an I/O component. Also, processors have memory. FIG. 3 is merely illustrative of an exemplary computing device 300 may be used in connection with one or more embodiments of the present disclosure. Distinction is not made between such categories as workstation, server, laptop, hand-held device and the like, as all are contemplated within the scope of FIG. 3 and reference to “the computing device 300.”

The computing device 300 typically includes a computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes the volatile and the nonvolatile, the removable and the non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies the computer-readable instructions, the data structures, the program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media includes wired media such as a wired network or direct-wired connection, and wireless media such as acoustic, RF, infrared and other wireless media. Combinations of any of the above should also be included within the scope of the computer-readable media.

Memory 304 includes the computer-storage media in the form of volatile and/or nonvolatile memory. The memory 304 may be removable, non-removable, or a combination thereof. Exemplary hardware devices include solid-state memory, hard drives, optical-disc drives and the like. The computing device 300 includes the one or more processors to read data from various entities such as memory 304 or I/O components 312. The one or more presentation components 308 present data indications to a user or other device. Exemplary presentation components include a display device, speaker, printing component, vibrating component and the like. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device and the like.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

We claim:

1. A computer-implemented method for predicting cost of transportation for one or more trips on real-time dynamic basis, the computer-implemented method comprising:
receiving, at a cost prediction system with a processor, a first set of data associated with one or more trips for transporting goods from a source place to a destination place, wherein the first set of data is received from a user through one or more communication devices;
fetching, at the cost prediction system with the processor, a historical data associated with transportation, wherein the historical data is obtained from a plurality of sources, wherein the historical data comprises a set of data associated with a plurality of vehicles and a plurality of lanes;
creating, at the cost prediction system with the processor, a profile of each type of vehicle of the plurality of vehicles by utilizing the historical data and real-time data associated with the plurality of vehicles, wherein the profile of each type of vehicle is created based on a plurality of factors;
creating, at the cost prediction system with the processor, a profile of the plurality of lanes by utilizing the historical data and the real-time data associated with the plurality of lanes, wherein the profile of the plurality of lanes is based on a plurality of historical lanes parameters;
analyzing, at the cost prediction system with the processor, the first set of data, the historical data, the data associated with the profile of each type of vehicle and the data associated with the profile of the plurality of lanes by utilizing machine learning and regression techniques, wherein the first set of data, the historical data, the data associated with the profile of each type of vehicle and the data associated with the profile of the plurality of lanes are analyzed to identify a pattern similar to the first set of data, wherein the analyzing is done in real time;
calculating, at the cost prediction system with the processor, the estimated cost of transportation for the one or more trips based on the analysis of the first set of data, the historical data, the data associated with the profile of each type of vehicle and the data associated with the profile of the plurality of lanes;
displaying, at the cost prediction system with the processor, the estimated cost of transporting goods from the source place to the destination place of the one or more trips, wherein the estimated cost is displayed on the one or more communication devices associated with the user; and
updating, at the cost prediction system with the processor, the estimated cost of transporting goods for the one or more trips on the real-time dynamic basis, wherein the estimated cost is updated based on a plurality of parameters.

2. The computer-implemented method as recited in claim 1, wherein the first set of data comprises source place, destination place, preference in selecting type of vehicle, preference in selecting length of vehicle, preference in selecting capacity of vehicle, data associated with the type of material to be transported, loading and unloading details, wherein the data associated with the type of material comprises packaged boxes, consumer boxes, food and agriculture, machine/auto parts, electronic goods, chemical powder, scrap, construction material, petroleum/paint, tyre, battery, cylinders, alcoholic beverages.

3. The computer-implemented method as recited in claim 1, wherein the historical data comprises price data associated with one or more past trips, data associated with the plurality of vehicles used in past trips, data associated with the one or more lanes used in past trips, data associated with a plurality of drivers, data associated with a plurality of source points and destination points, data associated with occurrence of entropy in the one or more past trips, data associated with the one or more past trips.

4. The computer-implemented method as recited in claim 1, wherein the plurality of factors associated with the profiling of vehicles comprises size of vehicles, weight of vehicles, material of vehicles, energy consumption rate of vehicles, efficiency of vehicles, model of vehicles, purchasing history of vehicles, maintenance history of vehicles, capacity of vehicles.

5. The computer-implemented method as recited in claim 1 further comprises storing, at the cost prediction system with the processor, the first set of data, the historical data, the data associated with the profile of each type of vehicle and data associated with the estimated cost.

6. The computer-implemented method as recited in claim 1, wherein the plurality of historical lane parameters comprises source point, destination point, width of lane, traffic probability, GDP ratio of origin and destination, total distance of lane, time taken to cover the distance of lane.

7. The computer-implemented method as recited in claim 1, wherein the profile of the lanes is analyzed to calculate the amount of fuel required for the one or more trips, cost of fuel required for the one or more trips, toll amount required for the one or more trips and selecting the optimized lane for the one or more trips.

8. The computer-implemented method as recited in claim 1, wherein the plurality of parameters comprises occurrence of entropy in the one or more trips or one or more similar trips, one or more offers or discounts in the parameters associated with the one or more trips, peak seasons.

9. The computer-implemented method as recited in claim 1, further comprising creating, at the cost prediction system with the processor, clusters of the one or more similar trips by applying algorithms over the historical data and the first set of data, wherein the clusters of the one or more similar trips is analyzed in real time to estimate the cost of transportation for the one or more trips.

10. The computer-implemented method as recited in claim 1, wherein the data associated with the plurality of lanes is used to determine the linkage between one or more parent lanes and corresponding one or more child lanes, wherein the linkage between the one or more parent lanes and the corresponding one or more child lanes is used to determine the cost of transportation for the one or more trips.

11. The computer-implemented method as recited in claim 1, wherein the estimated cost of transportation for the one or more trips is calculated by taking one or more factors into consideration, wherein the one or more factors include dry run of vehicle for a certain distance, demand availability, manufacturing and agriculture GDP (gross domestic product) of origin and destination place.

12. A computer system comprising:
one or more processors; and
a memory coupled to the one or more processors, the memory for storing instructions which, when executed by the one or more processors, cause the one or more processors to perform a method for predicting cost of transportation for one or more trips on real-time dynamic basis, the method comprising:
receiving, at a cost prediction system, a first set of data associated with one or more trips for transporting goods from a source place to a destination place, wherein the first set of data is received from a user through one or more communication devices;
fetching, at the cost prediction system, a historical data associated with transportation, wherein the historical data is obtained from a plurality of sources, wherein the historical data comprises a set of data associated with a plurality of vehicles and a plurality of lanes;
creating, at the cost prediction system, a profile of each type of vehicle of the plurality of vehicles by utilizing the historical data and real-time data associated with the plurality of vehicles, wherein the profile of each type of vehicle is created based on a plurality of factors;
creating, at the cost prediction system, a profile of the plurality of lanes by utilizing the historical data and the real-time data associated with the plurality of lanes, wherein the profile of the plurality of lanes is based on a plurality of historical lanes parameters;
analyzing, at the cost prediction system, the first set of data, the historical data and the data associated with the profile of each type of vehicle and the data associated with the profile of the plurality of lanes by utilizing machine learning and regression techniques, wherein the first set of data, the historical data, the data associated with the profile of each type of vehicle and the data associated with the profile of the plurality of lanes are analyzed to identify a pattern similar to the first set of data, wherein the analyzing is done in real time;
calculating, at the cost prediction system, the estimated cost of transportation for the one or more trips based on the analysis of the first set of data, the historical data and the data associated with the profile of each type of vehicle and the data associated with the profile of the plurality of lanes;
displaying, at the cost prediction system, the estimated cost of transporting goods from the source place to the destination place of the one or more trips, wherein the estimated cost is displayed on the one or more communication device associated with the user; and
updating, at the cost prediction system, the estimated cost of transporting goods for the one or more trips on the real-time dynamic basis, wherein the estimated cost is updated based on a plurality of parameters.

13. The computer system as recited in claim 12, wherein the first set of data comprises source place, destination place, preference in selecting type of vehicle, preference in selecting length of vehicle, preference in selecting capacity of vehicle, data associated with the type of material to be transported, loading and unloading details, wherein the data associated with the type of material comprises packaged boxes, consumer boxes, food and agriculture, machine/auto parts, electronic goods, chemical powder, scrap, construction material, petroleum/paint, tyre, battery, cylinders, alcoholic beverages.

14. The computer system as recited in claim 12, wherein the historical data further comprises price data associated with one or more past trips, data associated with the plurality of vehicles used in past trips, data associated with the one or more lanes used in past trips, data associated with a plurality of drivers, data associated with a plurality of source points and destination points, data associated with occurrence of entropy in the one or more past trips, data associated with the one or more past trips.

15. The computer system as recited in claim 12, wherein the plurality of factors associated with the profiling of vehicles comprises size of vehicles, weight of vehicles, material of vehicles, energy consumption rate of vehicles, efficiency of vehicles, model of vehicles, purchasing history of vehicles, maintenance history of vehicles, capacity of vehicles.

16. The computer system as recited in claim 12 further comprises storing, at the cost prediction system, the first set of data, the historical data, the data associated with the profile of each type of vehicle and data associated with the estimated cost.

17. The computer system as recited in claim 12, wherein the plurality of historical lane parameters comprises source point, destination point, width of lane, traffic probability, GDP ratio of origin and destination, total distance of lane, time taken by the vehicle to cover the distance of lane.

18. The computer-system as recited in claim 12, wherein the profile of the lanes is analyzed to calculate the amount of fuel required for the one or more trips, cost of fuel required for the one or more trips, toll amount required for the one or more trips and selecting the optimized lane for the one or more trips.

19. The computer system as recited in claim 12, wherein the plurality of parameters comprises occurrence of entropy in the one or more trips or one or more similar trips, one or more offers or discounts in the parameters associated with the one or more trips, peak seasons.

20. A non-transitory computer-readable storage medium encoding computer executable instructions that, when executed by at least one processor, performs for predicting cost of transportation for one or more trips on real-time dynamic basis, the method comprising:
receiving, at a computing device, a first set of data associated with one or more trips for transporting goods from a source place to a destination place, wherein the first set of data is received from a user through one or more communication devices;
fetching, at the computing device, a historical data associated with transportation, wherein the historical data is obtained from a plurality of sources, wherein the historical data comprises a set of data associated with a plurality of vehicles and a plurality of lanes;
creating, at the computing device, a profile of each type of vehicle of the plurality of vehicles by utilizing the historical data and real-time data associated with the plurality of vehicles, wherein the profile of each type of vehicle is created based on a plurality of factors;
creating, at the computing device, a profile of the plurality of lanes by utilizing the historical data and the real-time data associated with the plurality of lanes, wherein the profile of the plurality of lanes is based on a plurality of historical lanes parameters;
analyzing, at the computing device, the first set of data, the historical data, the data associated with the profile of each type of vehicle and the data associated with the profile of the plurality of lanes by utilizing machine learning and regression techniques, wherein the first set of data, the historical data, the data associated with the profile of each type of vehicle and the data associated with the profile of the plurality of lanes are analyzed to identify a pattern similar to the first set of data, wherein the analyzing is done in real time;
calculating, at the computing device, the estimated cost of transportation for the one or more trips based on the analysis of the first set of data, the historical data, the data associated with the profile of each type of vehicle and the data associated with the profile of the plurality of lanes;
displaying, at the computing device, the estimated cost of transporting goods from the source place to the destination place of the one or more trips, wherein the estimated cost is displayed on the one or more communication device associated with the user; and
updating, at the computing device, the estimated cost of transporting goods for the one or more trips on real-time dynamic basis, wherein the estimated cost is updated based on a plurality of parameters, wherein the plurality of parameters comprises occurrence of entropy in the one or more trips or one or more similar trips, one or more offers or discounts in the parameters associated with the one or more trips, peak seasons.
